(19) United States
(12) Patent Application Publication
(10) Pub. No.: US 2021/0359887 A1
(43) Pub. Date: Nov. 18, 2021

(54) Demodulation Reference Signal Sequence Generation Method and Apparatus

(71) Applicant: Telefonaktiebolaget LM Ericsson (publ), Stockholm (SE)

(72) Inventors: Zhipeng Lin, Nanjing Jiangsu (CN); Robert Baldemair, Solna (SE); Stefan Parkvall, Bromma (SE); Jianwei Zhang, Solna (SE); Robert Mark Harrison, Grapevine, TX (US)

(21) Appl. No.: 17/290,586

(22) PCT Filed: Oct. 29, 2019
(86) PCT No.: PCT/CN2019/114044

§ 371 Date: Apr. 30, 2021

(30) Foreign Application Priority Data
Nov. 2, 2018 (CN) PCT/CN2018/113612

(51) Int. Cl. H04L 27/26; H04L 5/00; H04W 72/04; H04L 1/00; H04L 1/18

(52) U.S. Cl. CPC H04L 27/2607; H04L 5/0051; H04L 1/1896; H04W 72/0446; H04L 1/0003; H04W 72/042

(57) ABSTRACT

The present disclosure provides a method (700) for generating a Demodulation Reference Signal, DM-RS, sequence for channel estimation and demodulation in New Radio network when transform pre-coding is enabled in transmissions. The method includes: determining (701) a cyclic shift value for cyclic shift of a base sequence; and generating (702) a corresponding Demodulation Reference Signal, DM-RS, sequence based on the cyclic shift value. The present disclosure also provides a DM-RS sequence generation apparatus, a UE and a base station.

### FIELD OF THE INVENTION

The present disclosure generally relates to wireless communication networks, and more specifically, to a Demodulation Reference Signal, DM-RS, sequence generation method and apparatus.

### BACKGROUND

New Radio (NR) network, also referred to the 5G communication network, is considered to be implemented in higher frequency bands (e.g., 60 GHz) to accomplish higher data rates and to meet more variety of service requirements.

The Demodulation Reference Signal (DM-RS) is generally used to demodulate data streams and estimate channel In the New Radio communication system, Demodulation Reference Signal, DM-RS, design is currently categorized in different aspects.

For example, as shown in FIG. 1, DM-RS can be either single symbol or double-symbol based DM-RS. As is shown, as an example, a block with black color represents, such as, an Orthogonal Frequency Division Multiplexing (OFDM) symbol in a Physical Resource Block (PRB).

FIG. 2 shows a schematic diagram illustrating frequency mapping of DM-RS where 2 types of mapping are defined. Type 1 represents comb based mapping with 2 Code Division Multiplexing (CDM) groups; and Type 2 represents non-comb based mapping with 3 CDM groups.

FIG. 3 shows a schematic diagram illustrating OFDM Symbol mapping of DM-RS where 2 types of mapping are defined. Type A represents slot based scheduling where DM-RS starts in symbol 3 or 4 from slot boundary; and Type B represents non-slot based scheduling where DM-RS starts in PxSCH symbol 1. Additional DM-RS symbols could be configured in both Type A and Type B.

FIG. 4 shows DM-RS port multiplexing where maximum 4 or 8 DM-RS ports can be multiplexed with type 1 DM-RS and maximum 6 or 12 ports can be multiplexed with type 2 DM-RS for single and double symbol DM-RS respectively. The dash block represents an Orthogonal Cover Code (OCC) group. The OCC shall be OCC in Frequency Domain (FD-OCC) only for single symbol DM-RS and shall be both FDD-OCC and OCC in Time Domain (TD-OCC) for multiplexing of the DM-RS ports for 2 symbol DM-RS.

FIG. 5 provides an example of Double-symbol Type 1 DM-RS ports multiplexing with both FD-OCC and TD-OCC, where r(i) is one sample of the DM-RS sequence, and one PRB is illustrated on 2 OFDM symbols with DM-RS. As can be seen in FIG. 5, 2 OCC code in frequency domain, 2 OCC code in time domain and 2 CDM groups provide 8 DM-RS ports.

DM-RS can be transmitted in an orthogonal fashion by transmitting the DM-RS in Resource Elements (REs) not occupied by other DM-RSs, or using a different Orthogonal Cover Code (OCC) from DM-RSs that occupy the same REs. Since the number of orthogonal DM-RSs is limited by the number of REs that the DM-RS occupies, it is desirable to support non-orthogonal DM-RSs as well. DM-RS generation in NR supports both orthogonal and non-orthogonal DM-RS generation.

When transform precoding is disabled, sequence generation is provided as below.

If transform precoding for Physical Uplink Shared Channel (PUSCH), is not enabled, the sequence r(n) shall be generated according to

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) )$$

where the pseudo-random sequence c(i) is defined in the related part in the Third Generation Partnership Project (3GPP). The pseudo-random sequence generator shall be initialized with

cᵢₙᵢₜ=(2¹⁷(N_{symb}^{slot}n_{s.f.}^{μ}+l+1)(+2N_{ID}ⁿ^{_{SCID}}+1)+2N_{ID}ⁿ^{_{SCID}}+n_{SCID})mod2³¹

where l is the OFDM symbol number within the slot, n_{s.f.}^{μ} is the slot number within a frame, n_{symb}^{slot} represents the number of symbols per slot; and
N_{ID}⁰, N_{ID}¹ϵ{0, 1, . . . , 65535} are given by the higher layer parameters scramblingID0 and scramblingID1, respectively, in the DMRS-UplinkConfig Information Element (IE) if provided and the PUSCH is scheduled by Downlink control information (DCI) format 0_1 or by a Type 1 PUSCH transmission with a configured grant;
N_{ID}⁰ϵ{0, 1, . . . , 65535} is given by the higher-layer parameter scramblingID0 in the DMRS-UplinkConfig IE if provided and the PUSCH is scheduled by DCI format 0_0 with the Cyclic Redundancy Check (CRC) scrambled by Cell-Radio Network Temporary Identifier (C-RNTI), Modulation and Coding Scheme-Cell-RNTI (MCS-C-RNTI), or Configured Scheduling—Radio Network Temporary Identifier (CS-RNTI);
N_{ID}ⁿ^{_{SCID}}=N_{ID}^{cell} otherwise.

The quantity n_{SCID}ϵ{0, 1} is indicated by the DM-RS initialization field, if present, in the DCI associated with the PUSCH transmission if DCI format 0_1 is used, otherwise, n_{SCID}=0. Mod ( )represents a Modulo function.

When transform precoding is enabled, sequence generation is provided as below.

If transform precoding for PUSCH is enabled, the reference-signal sequence r(n) shall be generated according to

r(n)=r_{u,v}^{(α,δ)}(n)

n=0,1, . . . , M_{sc}^{PUSCH}/2^{δ}−1

where r_{u,v}^{(α,δ)}(n) is given with δ=1 and α=0 for a PUSCH transmission dynamically scheduled by DCI; and M_{sc}^{PUSCH} represents scheduled bandwidth for uplink transmission, expressed as the number of subcarriers.

The sequence group u=(f_{gh}+n_{ID}^{RS})mod 30 , where n_{ID}^{RS} is given by
n_{ID}^{RS}=n_{ID}^{PUSCH} if n_{ID}^{PUSCH} is configured by the higher-layer parameter nPUSCH-Identity in the DMRS-UplinkConfig IE and the PUSCH is not a msg3 PUSCH according to the related part in 3 GPP.
n_{ID}^{RS}=N_{ID}^{cell} otherwise

where f_{gh} and the sequence number v are given by:
if neither group, nor sequence hopping shall be used

f_{gh}=0

v=0
if group hopping but not sequence hopping shall be used

f_{gh}=(Σₘ₌₀⁷2^{m}c(8(N_{symb}^{slot}n_{s.f}^{μ}+l)+m))mod30

v=0

where the pseudo-random sequence c(i) is defined in the related part in 3 GPP and shall be initialized with cᵢₙᵢₜ└n_{ID}^{RS}/30┘ at the beginning of each radio frame
if sequence hopping but not group hopping shall be used

$${f}_{gh} = 0$$

$$v = \{ \begin{matrix}c ( {N}_{symb}^{slot} {n}_{s , f}^{μ} + l ) & if {M}_{ZC} \geq 6 {N}_{sc}^{RB} \\ 0 & otherwise\end{matrix}$$

where the pseudo-random sequence c(i) is defined in the related part in 3 GPP and shall be initialized with cᵢₙᵢₜ=n_{ID}^{RS} at the beginning of each radio frame. M_{zc} represents the length of ZC sequence; and N_{sc}^{RB} represents the number of subcarriers per Resource Block.

The quantity above is the OFDM symbol number except for the case of double-symbol DM-RS in which case l is the OFDM symbol number of the first symbol of the double-symbol DM-RS.

Some parameters for the DM-RS generation for PUSCH transmissions are provided in RRC signaling in the IE DMRS-UplinkConfig, which can be included in both IE PUSCH-Config and IE ConfiguredGrantConfig (for configured grant transmissions):

```
DMRS-UplinkConfig ::=  SEQUENCE {
    dmrs-Type  ENUMERATED {type2}
OPTIONAL, -- Need S
    dmrs-AdditionalPosition  ENUMERATED {pos0, pos1, p0s3}
OPTIONAL, -- Need R
    phaseTrackingRS  SetupRelease { PTRS-UplinkConfig }
OPTIONAL, -- Need M
    maxLength  ENUMERATED {len2}
OPTIONAL, -- Need S
    transformPrecodingDisabled  SEQUENCE {
        scramblingID0 INTEGER (0..65535)
OPTIONAL, -- Need S
        scramblingID1 INTEGER (0..65535)
OPTIONAL, -- Need S
        ...
    }
OPTIONAL, -- Need R
    transformPrecodingEnabled  SEQUENCE { [symbol]
                        INTEGER(0..1007)
OPTIONAL, -- Need S
      sequenceGroupHopping  ENUMERATED {disabled}
OPTIONAL, -- Need S
      sequenceHopping  ENUMERATED {enabled}
OPTIONAL, -- Need S
      ...
    }
OPTIONAL, -- Need R
    ...
}
```

In NR system in 3 GPP, transmission schemes with multiple transmissions multiplexed on the same time frequency resource is described as below.

As is known, one type of scheme with UEs co-scheduled in the same TF resource is Multi-User Multiple-Input Multiple-Output (MU-MIMO), where more than one UE will transmit data in the same allocated time and frequency resources but with different DM-RS ports for each UE.

Besides MU-MIMO, another type of transmission scheme with UEs co-scheduled in the same TF resource is non-orthogonal multiple access (NOMA).

In Release 15 standardization of the New Radio (NR) in 3 GPP, a study item has been approved for evaluating and further providing recommendation on non-orthogonal multiple access (NOMA) scheme(s).

NOMA schemes are generally based on interleaving, scrambling, or spreading methods and mapping user data on resources that are shared among multiple users. In NOMA, User Equipment (UE) transmissions are overlapping on shared time and frequency resources, by using properly designed sequences/vectors in order to spread the information symbols in frequency. The idea behind the NOMA paradigm is that the clever design of spreading vectors can facilitate the implementation of advanced multi-user detectors (MUD), such as the minimum-mean squared-error (MMSE) detector or the maximum a posteriori (MAP) detector, in order to improve the joint detection/demodulation of the superimposed UE transmissions. The system can then achieve enhanced performance, in terms of sum-rate and/or number of supported UEs, when NOMA-enabled UEs are sharing the time/frequency resources and effective MUD solutions are used to separate their data signals.

Traditionally, signal transmission to or from multiple UEs in a cellular network is preferably done by ensuring, or at least attempting to ensure, orthogonality of the transmitted signals with conventional orthogonal multiple access (COMA) via orthogonal time, frequency, code, or spatial allocation of the transmitted signal resources. Additionally, to account for imperfections in such allocation or in the propagation channel, restoring orthogonality is the aim of receiver procedures, using equalizers, Interference Rejection Combining (IRC)-like and other MMSE-like receivers for e.g. Spread-OFDM (S-OFDM) or MIMO transmission, but also non-linear variants of such receivers.

In some scenarios, the network prioritizes the ability to handle a larger number of users over given resources than would be allowed according to the OMA approach, e.g. when the available degrees of freedom (DoF) are fewer than the number of users to be served. Multiple users can then be scheduled in same resources, according to a NOMA approach, with the inherent realization that the users' signals will not be substantially orthogonal at the receiver. Rather, there will exist residual inter-user interference that needs to be handled by the receiver. By the nature of NoMA transmission, multiple signals are received non-orthogonally and the overlapping signals must generally be separated by the receiver prior to decoding. To assist in that handling, it is a known technique to impose UE-specific signature sequences on the individual UEs' signals; the receiver can then use the presence of the signature sequences to facilitate extracting the individual users' signals. Another equivalent view is that invoking the signature sequences allows the effective end-to-end channel to be made closer to diagonal.

An overloading factor in NOMA or MU-MIMO can be defined as the number of UEs co-scheduled in the same TF resources.

As known from above, when transform precoding is enabled (i.e. when Discrete Fourier Transform Spread OFDM (DFTS-OFDM) waveform is used), only the DM-RS sequence design for dynamic grant-based transmissions are specified. Therefore, it is necessary to specify or define a DM-RS sequence generation method for the configured grant based transmissions (e.g., PUSCH transmission) when transform precoding is enabled.

### SUMMARY

In view of the above, it is an object to provide a DM-RS sequence generation method and apparatus for demodulation and channel estimation in New Radio network for the configured grant based transmissions (e.g., PUSCH transmission) when transform precoding is enabled. It is also applicable to the dynamic grant based transmissions when transform precoding is enabled.

According to one aspect of the disclosure, there is provided a method for generating a Demodulation Reference Signal, DM-RS, sequence for channel estimation and demodulation in a wireless network, particularly a New Radio network, when transform pre-coding is enabled in transmissions, comprising determining a cyclic shift value for cyclic shift of a base sequence; and generating a corresponding Demodulation Reference Signal, DM-RS, sequence based on the cyclic shift value.

In an embodiment, the cyclic shift value is different from one transmission to another.

In an embodiment, the method may further comprises configuring the cyclic shift value in Radio Resource Control, RRC, signaling or Downlink Control Information, DCI, for each transmission or for a group of transmissions.

In an embodiment, the cyclic shift value is determined as a function of one or more configuration parameters of RRC or DCI information.

In an embodiment, the cyclic shift value is determined as a function of a cell ID or a fixed value.

In an embodiment, the cyclic shift value α is determined by a formula, α=mod (nPUSCH-Identity, N)*PI/N, where N is a predefined or configured value, nPUSCH-Identity is a configuration parameter of RRC information element, mod ( ) represents a Modulo function and PI is π value.

Alternatively, the cyclic shift value α is determined by a formula, α=mod (nPUSCH-Identity, N)*2PI/N, where N is a predefined or configured value, nPUSCH-Identity is a configuration parameter of RRC information element, mod ( ) represents a Modulo function and PI is π value.

In an embodiment, N is a number of different cyclic shift values.

In an embodiment, the cyclic shift value is determined to be different between initial transmission and retransmissions.

In an embodiment, the cyclic shift value is determined to be different among retransmissions.

In an embodiment, the cyclic shift value is determined to be different for transmissions with repetition.

In an embodiment, the cyclic shift value is determined based on Radio Network Temporary Identity, RNTI, values.

In an embodiment, the cyclic shift value is determined based on signature IDs in case of Non-orthogonal Multiple Access, NoMA, transmission.

In an embodiment, the cyclic shift value α is determined by a formula, α=signature ID mod N, where N is a predefined value.

In an embodiment, N is a number of available cyclic shift values.

In an embodiment, the cyclic shift value is determined based on time or frequency configuration or allocation of a transmission.

In an embodiment, the cyclic shift value is determined based on at least one of a slot number, a symbol number, a Resource Block, RB, number used in the transmission, and a preconfigured resource in the transmission.

In an embodiment, the preconfigured resource is periodicity in a configuration parameter ConfiguredGrantConfig.

In an embodiment, the determining comprises: randomly selecting the cyclic shift value by User Equipment, UE, from more than one cyclic shift candidate values.

In an embodiment, the cyclic shift value is determined based on at least one of the factors: overloading factor; Modulation and Coding Scheme, MCS, value; UE measurement parameters; network measurement parameters; an ACK/NACK indication; Time Frequency resources availability; and Time Transmission Interval, TTI, requirement.

In an embodiment, the UE measurement parameters include Reference Signal Received Power, RSRP, and Reference Signal Received Quality, RSRQ.

In an embodiment, the network measurement parameters include Signal to Noise Ratio, SNR, signal power, timing offset and frequency offset based on transmissions from the UE.

In an embodiment, the method is applied to a configured grant based PUSCH transmissions.

In an embodiment, the method is applied to a dynamic grant based PUSCH transmissions.

According to another aspect of the disclosure, there is provided with a Demodulation Reference Signal, DM-RS, sequence generation apparatus for channel estimation and demodulation in a wireless network, particularly a New Radio network, comprising: one or more processors; and one or more memories comprising computer program configured to, when executed by the one or more processors, cause the DM-RS sequence generation apparatus to execute any of the methods in the embodiments.

According to another aspect of the disclosure, there is provided with a Demodulation Reference Signal, DM-RS, sequence generation apparatus for channel estimation and demodulation in a wireless network, particularly a New Radio network, comprising: a determining module configured to determine a cyclic shift value for cyclic shift of a base sequence when transform pre-coding is enabled in transmissions; and a generation module configured to generate a corresponding Demodulation Reference Signal, DM-RS, sequence based on the cyclic shift value.

According to another aspect of the disclosure, there is provided with a User Equipment comprising the DM-RS sequence generation apparatus according to the embodiments of the disclosure.

According to another aspect of the disclosure, there is provided with a base station comprising the DM-RS sequence generation apparatus according to the embodiments of the disclosure.

According to another aspect of the disclosure, there is provided with a computer-readable medium having computer program stored thereon, wherein the computer program comprises codes for performing the method according to the embodiments of the disclosure.

According to the embodiments of the present disclosure, a DM-RS sequence generation method is specified or defined for the configured grant based transmissions (e.g., PUSCH transmission) when transform precoding is enabled. The DM-RS sequence generation method for the dynamic grant based transmissions is complemented and enhanced. This can improve the channel estimation accuracy and demodulation performance, especially for different UEs co-scheduled in the same timing frequency resource (e.g. in NOMA or MU-MIMO) or for UEs in different cells.

### BRIEF DESCRIPTION OF THE DRAWINGS

The above and other objects, features and advantages will be more apparent from the following description of embodiments with reference to the accompanied drawings, in which:

FIG. 1 is a schematic diagram illustrating single-symbol or double-symbol based DM-RS used in New Radio (NR) network;

FIG. 2 is a schematic diagram illustrating frequency mapping of DM-RS used in NR network;

FIG. 3 is a schematic diagram illustrating OFDM symbol mapping of DM-RS used in NR network;

FIG. 4 is a schematic diagram illustrating DM-RS ports multiplexing used in NR network;

FIG. 5 is a schematic diagram illustrating double-symbol, Type 1 DM-RS ports multiplexing with both FD-OCC and TD-OCC used in NR network;

FIG. 6 is a schematic diagram illustrating a network architecture applicable in the present disclosure;

FIG. 7 is a flowchart diagram illustrating a DM-RS sequence generation method in NR transmission in accordance with an embodiment of the disclosure;

FIGS. 8A and 8B are schematic block diagrams representing a DM-RS generation apparatus in accordance with an embodiment of the disclosure;

FIG. 9A is schematic block diagrams representing a UE including a DM-RS generation apparatus in accordance with an embodiment of the disclosure;

FIG. 9B is schematic block diagrams representing a base station including a DM-RS generation apparatus in accordance with an embodiment of the disclosure;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12 to 15 are flowcharts illustrating methods implemented in a communication system including a host computer, a base station and a user equipment.

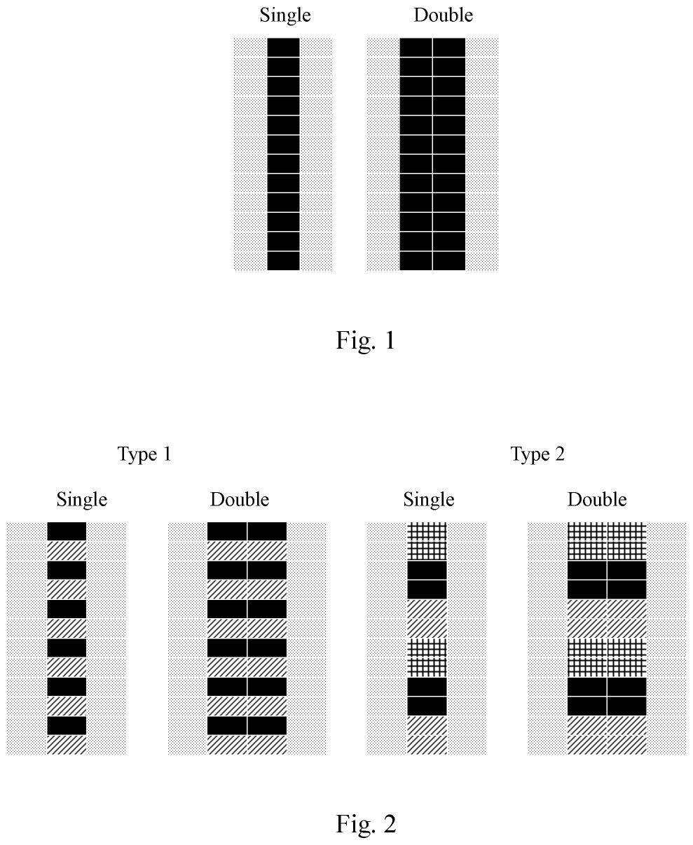

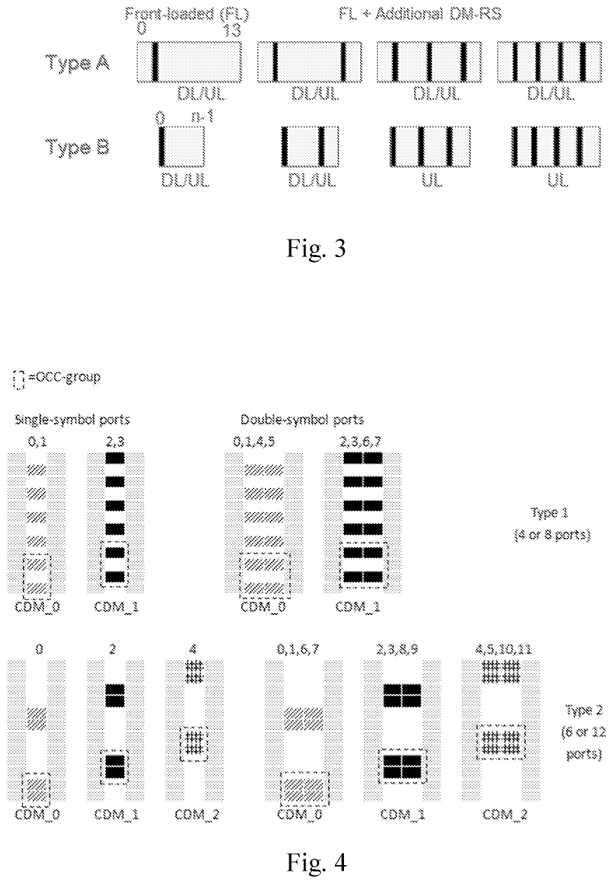

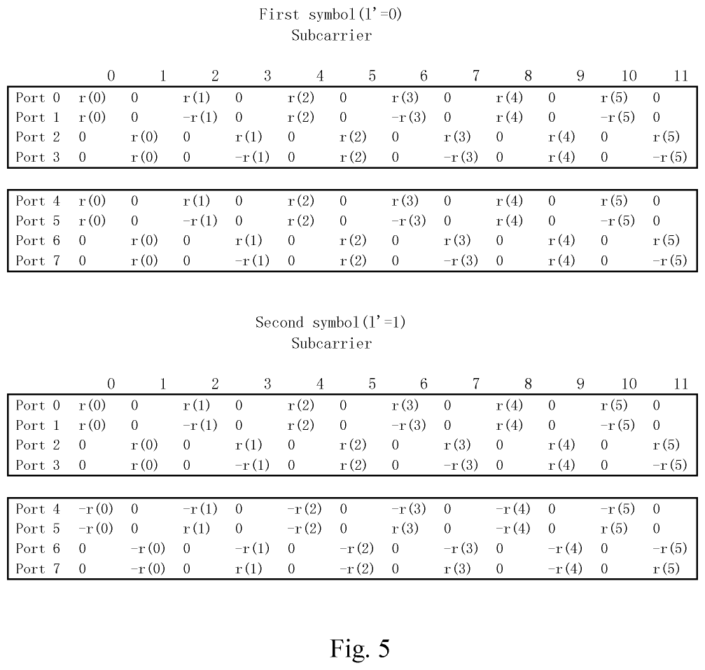

### DETAILED DESCRIPTION

Following embodiments of the present disclosure are described in detail with reference to the accompanying drawings. It shall be understood that these embodiments are discussed only for the purpose of enabling those skilled persons in the art to better understand and thus implement the present disclosure, rather than suggesting any limitations on the scope of the present disclosure.

In the context, the term “base station” may refer to any network device in a wireless communication network in which the embodiments of the present disclosure may be applied. Generally, the base station refers to a network device via which a User Equipment (UE) may access the network and receives services therefrom. Generally, The base station may be, for example, a Node B (NodeB or NB), an evolved NodeB (eNodeB or eNB), or gNodeB (gNB), a Remote Radio Unit (RRU), a Radio Header (RH), a Remote Radio Head (RRH), a relay, a low power node such as a femto, a pico, and so forth. Yet further examples of the network device may include Multi-Standard Radio (MSR) equipment such as MSR BSs, network controllers such as Radio Network Controllers (RNCs) or Base Station Controllers (BSCs), Base Transceiver Stations (BTSs), transmission points, transmission nodes. More generally, the network device may represent any suitable device (or group of devices) capable, configured, arranged, and/or operable to enable and/or provide UE access to the wireless communication network or to provide some service to UE that has accessed the wireless communication network.

The term “User Equipment” or “UE” may refer to any terminal device in a wireless communication network in which the embodiments of the present disclosure may be applied. Generally, the UE refers to any terminal device that can access a wireless communication network and receive services therefrom. By way of example and not limitation, the UE may refer to a mobile terminal or other suitable user devices. The UE may be, for example, a Subscriber Station (SS), a Portable Subscriber Station, a Mobile Station (MS), or an Access Terminal (AT). The UE may include, but not limited to, portable computers, image capture terminal devices such as digital cameras, gaining terminal devices, music storage and playback appliances, a mobile phone, a cellular phone, a smart phone, voice over IP (VoIP) phones, wireless local loop phones, a tablet, a wearable device, a personal digital assistant (PDA), portable computers, desktop computer, image capture terminal devices such as digital cameras, gaining terminal devices, music storage and playback appliances, wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a UE may be configured to transmit and/or receive information without direct human interaction. For instance, a UE may be designed to transmit information to a network device on a predetermined schedule, when triggered by an internal or external event, or in response to requests from the wireless communication network. Instead, a UE may represent a device that is intended for sale to, or operation by, a human user but that may not initially be associated with a specific human user.

In the context of the disclosure, the term “wireless communication network” refers to a network following any suitable communication standards, such as new radio (NR), Long Term Evolution (LTE), LTE-Advanced (LTE-A), Wideband Code Division Multiple Access (WCDMA), High-Speed Packet Access (HSPA), and any further suitable networks to be developed. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the First Generation), 2G (the Second Generation), 2.5G, 2.75G, 3G (the Third Generation), 4G (the Fourth Generation), 4.5G, 5G (the Fifth Generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

As used herein, a downlink (DL) transmission refers to a transmission from the base station to a UE/terminal device, and an uplink (UL) transmission refers to a transmission in an opposite direction.

Generally, the UE may transmit e.g. Scheduling Request signaling on PUCCH to the base station. The base station in turn may send back a scheduling grant with assigned resource to the UE on Physical Downlink Control Channel (PDCCH). Then, UE obtains the scheduling grants from the network device. In the context, the scheduling grant with assigned transmission resources sent from the base station to the UE in response to the scheduling request from the UE is generally referred to a dynamic grant. The transmission with resources assigned by the dynamic grant is referred to a dynamic grant based transmission. The scheduling grant with containing the transmission resources pre-configured by the base station to the UE (no scheduling request is required from the UE) is generally referred to a configured grant. The transmission with pre-configured resources by a configured grant is referred to a configured grant based transmission.

Configured grant is also called Semi-Persistent Scheduling, which can be used in both downlink and uplink. For the DL SPS, a DL assignment is provided by PDCCH, and stored or cleared based on L1 signaling indicating SPS activation or deactivation.

There are two types of transmission without dynamic grant:
configured grant Type 1 where an uplink grant is provided by RRC, and stored as configured uplink grant;
configured grant Type 2 where an uplink grant is provided by PDCCH, and stored or cleared as configured uplink grant based on L1 signalling indicating configured uplink grant activation or deactivation.

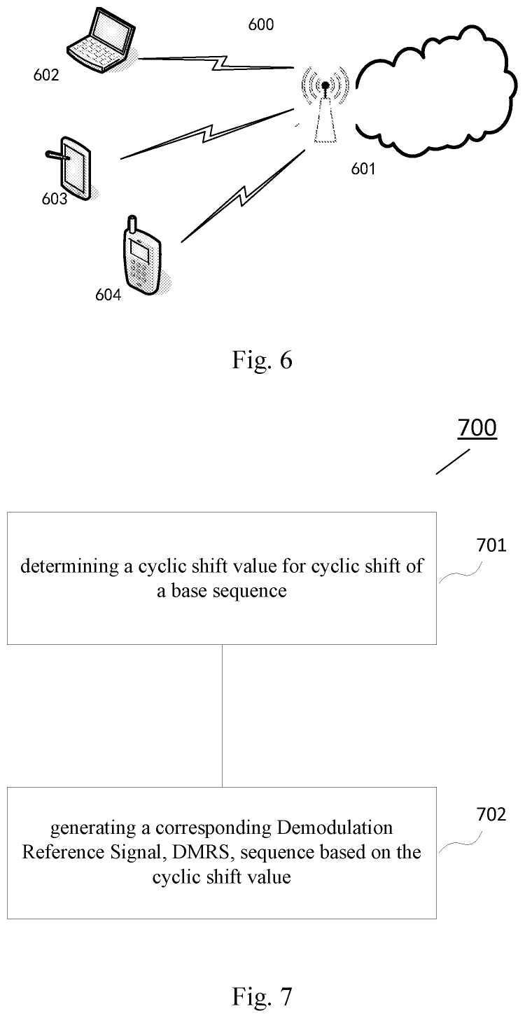

FIG. 6 is a diagram illustrating a schematic network architecture 600 applicable in the present disclosure. The schematic network architecture may include e.g., a base station (e.g., gNB) 601 and a UE 602, 603, 604 which may be connected to the base station to access the network services. For example, the base station generates DM-RS sequence and sends to UE by mapping the DM-RS sequence onto the corresponding time frequency resource; and the UE receives the DM-RS sequence and also generates local DM-RS sequence for demodulation and channel estimation.

In particular, in a wireless communication network such as a NR network, in order to make full use of space resources, a network device can be equipped with multiple antennas to transmit data by using Multiple-Input Multiple-Output (MIMO) technology, that is, network devices can transmit multiple data streams in the same time-frequency resource. Each data stream is transmitted on a separate spatial layer, and data transmitted at each spatial layer may be mapped to a different antenna port for transmission. Since the channel coefficients of different antenna ports to terminals are different, the channel coefficients between each antenna port and the terminal device need to be estimated when performing channel estimation. Therefore, the network device configures different DM-RS sequences for each antenna port or each transmission, and sends the DM-RS corresponding to each antenna port or each transmission to the UE for demodulation and channel estimation. Further, for example, for uplink, in MU-MIMO, multiple UEs may send different data streams on the same timing frequency resource but with different DMRS ports allocated.

Using different cyclic shifted base sequences for DM-RS sequence generation can mitigate the DM-RS collision and DM-RS interference to improve the channel estimation accuracy and demodulation performance, especially for different UEs co-scheduled in the same timing frequency resource (e.g. in NOMA or MU-MIMO) or for UEs in different cells.

FIG. 7 is a flowchart diagram illustrating a DM-RS sequence generation method 700 in transmissions in accordance with an embodiment of the disclosure.

The method 700 may be applicable, among others, in transmissions (e.g., PUSCH transmission) with configured grant or dynamic grant in New Radio network where transform pre-coding is enabled. As exemplary and not limited, the method may be applicable to any wireless communication network and scenarios where it can be applied.

The method 700 is adapted to generate a DM-RS sequence for channel estimation and demodulation in New Radio network when transform pre-coding is enabled in transmissions.

The method 700 includes step 701 and step 702. In step 701, a cyclic shift value is determined for cyclic shift of a base sequence. In step 702, a corresponding Demodulation Reference Signal, DM-RS, sequence is generated based on the cyclic shift value. The cyclic shift value can be fixed (e.g., α=0) or changed when required. e.g., the cyclic shift value may be different from one transmission to another.

In an embodiment, when transform precoding for e.g. PUSCH is enabled, the DM-RS reference-signal sequence r(n) may be generated according to, e.g.,

r(n)=r_{u,v}^{(α,δ)}(n)

n=0,1, . . . , M_{sc}^{PUSCH}/2^{δ}−1

where r_{u,v}^{(α,δ)}(n) may be defined by a cyclic shift α of a base sequence r̅_{u,v}(n) according to

r_{u,v}^{(α,δ)}(n)=e^{jαn}r̅_{u,v}(n), 0≤n<M_{ZC}

where M_{ZC}=mN_{sc}^{RB}/2^{δ} is the length of the sequence. δ is used to control the sparse degree of DM-RS in a Physical Resource Block, e.g., δ=1. Multiple sequences may be generated from a single base sequence through different values of α and δ for transmissions (e.g., PUSCH transmission) with configured grant in New Radio network where transform pre-coding is enabled.

Base sequences r̅_{u,v}(n) are divided into groups, where uϵ{0,1, . . . , 29} is the group number v is the base sequence number within the group, such that each group contains one base sequence (v=0) of each length M_{ZC}=mN_{sc}^{RB}/2^{δ}, 1/2≤m/2^{δ}≤5 and two base sequences (v=0,1) of each length M_{ZC}=mN_{sc}^{RB}/2^{δ}, 6≤m/2^{δ}. The definition of the base sequence r̅_{u,v}(0), . . . , r̅_{u,v}(M_{ZC}−1) depends on the sequence length M_{ZC}.

The DM-RS sequences, when transform precoding is used, may be e.g. ZC sequences based on the base sequence cyclic shifted differently with variable cyclic shift values α.

As an example, the cyclic shift value α may be explicitly indicated by or included in Radio Resource Control, RRC, signaling or Downlink Control Information, DCI, for each transmission or for a group of transmissions.

Alternatively, the cyclic shift value α may be predefined or implicitly determined.

In an embodiment, the cyclic shift value α may be determined as a function of one or more configuration parameters of RRC or DCI information; or as a function of a cell ID or a fixed value when the configuration parameter is unavailable. As an example, α may be configured with a function of the configuration parameter nPUSCH-Identity provided in RRC information element DMRS-UplinkConfig. When nPUSCH-Identity is not available, α may be configured with cell-id or fixed value (e.g. 0).

When nPUSCH-Identity is available, as an example, α may be determined as α=mod (nPUSCH-Identity,N)*PI/N with N a predefined or configured value, e.g. N could be the number of different α values. Mod ( )is a modulo function, and PI is π value.

As another example, α may be determined as α=mod (nPUSCH-Identity,N)*2PI/N with N a predefined or configured value, e.g. N could be the number of different a values. Mod ( )is a modulo function, and PI is π value.

In an embodiment, the cyclic shift value α may be configured to be different between initial transmission and retransmissions. Further, the cyclic shift value α may be configured to be different among different transmissions; or the cyclic shift value α may be configured to be different for transmissions with repetition.

For example, for initial transmission use, the cyclic shift value α may be set to 0; for retransmissions, α may be set to PI/2. More values may be used for different re-transmissions, for example, PI/3 and PI/4.

In an embodiment, the cyclic shift value α may be determined based on Radio Network Temporary Identity, RNTI, values.

For example, for odd RNTI values, the cyclic shift value α may be set to 0; for even RNTI values, the cyclic shift value α may be set to PI/2.

As another example, for Configured Scheduling—Radio Network Temporary Identifier (CS-RNTI), the cyclic shift value α may be set to PI/2 (e.g., for configured grant); for Cell-Radio Network Temporary Identifier (C-RNTI), the cyclic shift value α may be set to 0 (e.g., for dynamic grant, or when blind detection of DM-RS is allowed).

In an embodiment, the cyclic shift value may be determined based on signature IDs in case of Non-orthogonal Multiple Access, NoMA, transmission.

As an example, α=signature-id mod N, where N is can be a predefined value. For example, N could be the number of available cyclic shift values.

In an embodiment, the cyclic shift value may be determined based on time and frequency configuration or allocation of a transmission.

For example, the cyclic shift value may be determined based on at least one of a slot number, a symbol number, a Resource Block, RB, number used in the transmission, and a preconfigured resource in the transmission. For example, the preconfigured resource could be the periodicity in configuration parameter ConfiguredGrantConfig defined in TS 3GPP.

In an embodiment, the cyclic shift value may be randomly selected by User Equipment, UE, from more than one cyclic shift candidate values. This means the network needs to do blind detection, but could randomize collisions of DMRSs between UEs.

In an embodiment, the cyclic shift value may be determined based on at least one of the factors: overloading factor; Modulation and Coding Scheme, MCS, value; UE measurement parameters; network measurement parameters; an ACK/NACK indication; Time Frequency resources availability; and Time Transmission Interval, TTI, requirement.

As an example, UE measurement parameters may include Reference Signal Received Power, RSRP, and Reference Signal Received Quality, RSRQ. The network measurement parameters may include Signal to Noise Ratio, SNR, signal power, timing offset and frequency offset based on transmissions from the UE.

In another example, the cyclic shift value may be determined to be a value different from zero based on at least one of the above factors.

According to the above embodiments of the method 700, different cyclic shifted base sequences (i.e., depending on the different value of α) are utilized for DM-RS sequence generation in transmissions in New Radio network where transform pre-coding is enabled. This can mitigate the DM-RS collision and DM-RS interference to improve the channel estimation accuracy and demodulation performance, especially in case of different UEs co-scheduled in the same timing frequency resource (e.g. in NOMA or MU-MIMO) or for UEs in different cells.

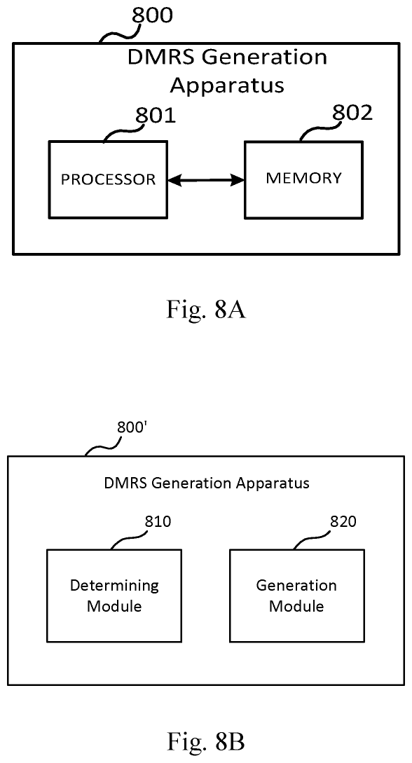

FIGS. 8A and 8B are schematic block diagrams representing a DM-RS generation apparatus in accordance with an embodiment of the disclosure.

The DM-RS generation apparatus 800 or 800′ as shown in FIG. 8A and FIG. 8B may generate a DM-RS sequence for channel estimation and demodulation in New Radio network. As an example, the DM-RS generation apparatus 800 in FIG. 8A may include one or more processors 801 and one or more memories 802. The memories may include computer program configured to, when executed by the one or more processors, cause the DM-RS sequence generation apparatus to generate DM-RS sequence according to the embodiments.

As another example, the DM-RS generation apparatus 800′ in FIG. 8B may include a determining module 810 and a generation module 820. The determining module 810 may determine a cyclic shift value for cyclic shift of a base sequence when transform pre-coding is enabled in transmissions; and the generation module 820 may generate a corresponding DM-RS sequence based on the cyclic shift value. The cyclic shift value may be fixed or varied, which may be determined in the manner as described above and will not be repeated here.

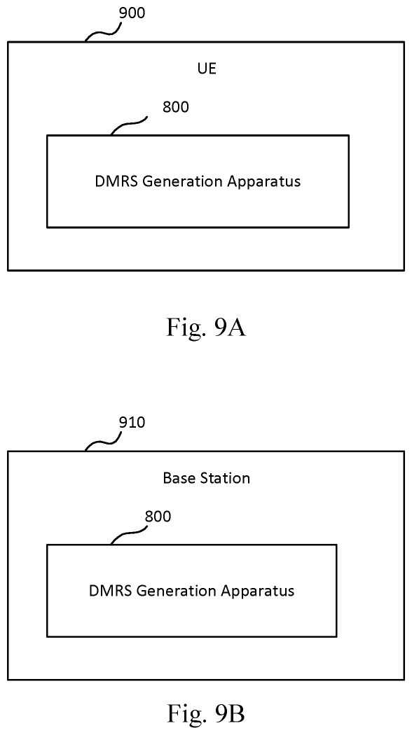

FIG. 9A is schematic block diagrams representing a UE 900 in accordance with an embodiment of the disclosure. The UE 900 may include a DM-RS generation apparatus which generates a DM-RS sequence based on the selection of the cyclic shift value for cyclic shift of the base sequence, for channel estimation and demodulation in New Radio network when transform pre-coding is enabled in transmissions.

FIG. 9B is schematic block diagrams representing a base station 910 in accordance with an embodiment of the disclosure. The base station 910 may include a DM-RS generation apparatus which generates a DM-RS sequence based on the selection of the cyclic shift value for cyclic shift of the base sequence, for channel estimation and demodulation in New Radio network when transform pre-coding is enabled in transmissions.

It is to be noted that the DM-RS sequence generation method and apparatus in the context may be applicable not only to the configured grant based transmissions (e.g., PUSCH transmission) when transform precoding is enabled, but also to the dynamic grant based transmissions (e.g., PUSCH transmission) when transform precoding is enabled.

The present disclosure also provides a computer-readable medium having computer program stored thereon, wherein the computer program comprises codes for performing the methods at UE side or at network device side in accordance with the embodiments of the disclosure.

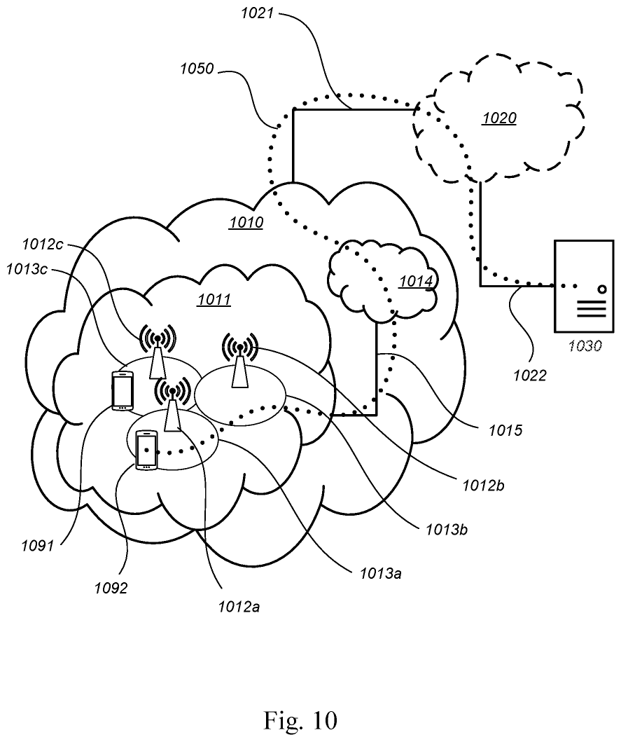

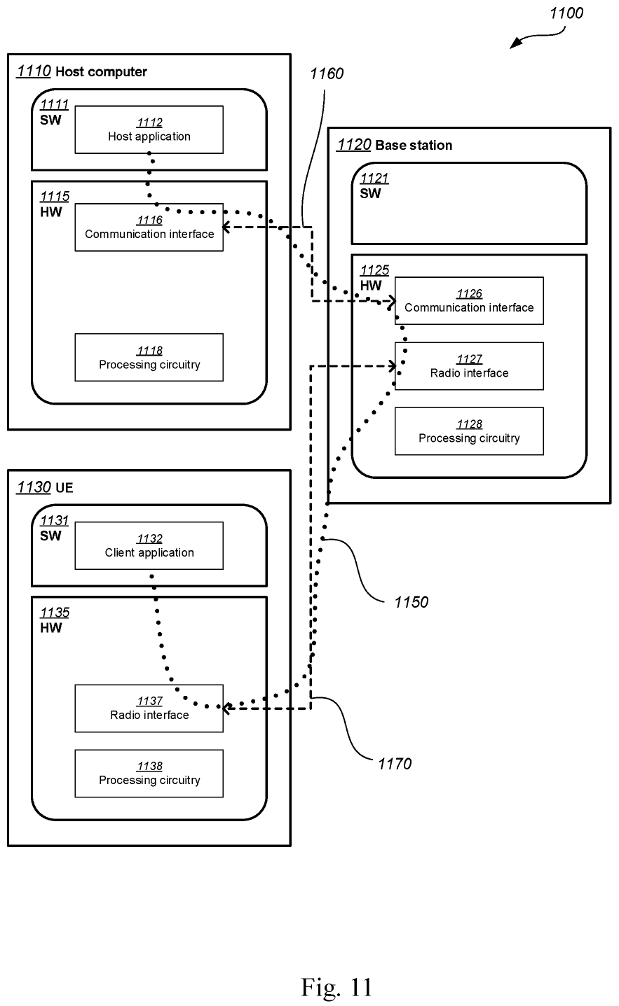

FIG. 10 schematically illustrates a telecommunication network connected via an intermediate network to a host computer.

With reference to FIG. 10, in accordance with an embodiment, a communication system includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first user equipment (UE) 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown).

The communication system of FIG. 10 as a whole enables connectivity between one of the connected UEs 1091, 1092 and the host computer 1030. The connectivity may be described as an over-the-top (OTT) connection 1050. The host computer 1030 and the connected UEs 1091, 1092 are configured to communicate data and/or signaling via the OTT connection 1050, using the access network 1011, the core network 1014, any intermediate network 1020 and possible further infrastructure (not shown) as intermediaries. The OTT connection 1050 may be transparent in the sense that the participating communication devices through which the OTT connection 1050 passes are unaware of routing of uplink and downlink communications. For example, a base station 1012 may not or need not be informed about the past routing of an incoming downlink communication with data originating from a host computer 1030 to be forwarded (e.g., handed over) to a connected UE 1091. Similarly, the base station 1012 need not be aware of the future routing of an outgoing uplink communication originating from the UE 1091 towards the host computer 1030.

FIG. 11 is a generalized block diagram of a host computer communicating via a base station with a user equipment over a partially wireless connection.

Example implementations, in accordance with an embodiment, of the UE, base station and host computer discussed in the preceding paragraphs will now be described with reference to FIG. 11. In a communication system 1100, a host computer 1110 comprises hardware 1115 including a communication interface 1116 configured to set up and maintain a wired or wireless connection with an interface of a different communication device of the communication system 1100. The host computer 1110 further comprises processing circuitry 1118, which may have storage and/or processing capabilities. In particular, the processing circuitry 1118 may comprise one or more programmable processors, application-specific integrated circuits, field programmable gate arrays or combinations of these (not shown) adapted to execute instructions. The host computer 1110 further comprises software 1111, which is stored in or accessible by the host computer 1110 and executable by the processing circuitry 1118. The software 1111 includes a host application 1112. The host application 1112 may be operable to provide a service to a remote user, such as a UE 1130 connecting via an OTT connection 1150 terminating at the UE 1130 and the host computer 1110. In providing the service to the remote user, the host application 1112 may provide user data which is transmitted using the OTT connection 1150.

The communication system 1100 further includes a base station 1120 provided in a telecommunication system and comprising hardware 1125 enabling it to communicate with the host computer 1110 and with the UE 1130. The hardware 1125 may include a communication interface 1126 for setting up and maintaining a wired or wireless connection with an interface of a different communication device of the communication system 1100, as well as a radio interface 1127 for setting up and maintaining at least a wireless connection 1170 with a UE 1130 located in a coverage area (not shown in FIG. 11) served by the base station 1120. The communication interface 1126 may be configured to facilitate a connection 1160 to the host computer 1110. The connection 1160 may be direct or it may pass through a core network (not shown in FIG. 11) of the telecommunication system and/or through one or more intermediate networks outside the telecommunication system. In the embodiment shown, the hardware 1125 of the base station 1120 further includes processing circuitry 1128, which may comprise one or more programmable processors, application-specific integrated circuits, field programmable gate arrays or combinations of these (not shown) adapted to execute instructions. The base station 1120 further has software 1121 stored internally or accessible via an external connection.

The communication system 1100 further includes the UE 1130 already referred to. Its hardware 1135 may include a radio interface 1137 configured to set up and maintain a wireless connection 1170 with a base station serving a coverage area in which the UE 1130 is currently located. The hardware 1135 of the UE 1130 further includes processing circuitry 1138, which may comprise one or more programmable processors, application-specific integrated circuits, field programmable gate arrays or combinations of these (not shown) adapted to execute instructions. The UE 1130 further comprises software 1131, which is stored in or accessible by the UE 1130 and executable by the processing circuitry 1138. The software 1131 includes a client application 1132. The client application 1132 may be operable to provide a service to a human or non-human user via the UE 1130, with the support of the host computer 1110. In the host computer 1110, an executing host application 1112 may communicate with the executing client application 1132 via the OTT connection 1150 terminating at the UE 1130 and the host computer 1110. In providing the service to the user, the client application 1132 may receive request data from the host application 1112 and provide user data in response to the request data. The OTT connection 1150 may transfer both the request data and the user data. The client application 1132 may interact with the user to generate the user data that it provides.

It is noted that the host computer 1110, base station 1120 and UE 1130 illustrated in FIG. 11 may be identical to the host computer 3230, one of the base stations 3212a, 3212b, 3212c and one of the UEs 3291, 3292 of FIG. 32, respectively. This is to say, the inner workings of these entities may be as shown in FIG. 11 and independently, the surrounding network topology may be that of FIG. 32.

In FIG. 11, the OTT connection 1150 has been drawn abstractly to illustrate the communication between the host computer 1110 and the use equipment 1130 via the base station 1120, without explicit reference to any intermediary devices and the precise routing of messages via these devices. Network infrastructure may determine the routing, which it may be configured to hide from the UE 1130 or from the service provider operating the host computer 1110, or both. While the OTT connection 1150 is active, the network infrastructure may further take decisions by which it dynamically changes the routing (e.g., on the basis of load balancing consideration or reconfiguration of the network).

The wireless connection 1170 between the UE 1130 and the base station 1120 is in accordance with the teachings of the embodiments described throughout this disclosure. One or more of the various embodiments improve the performance of OTT services provided to the UE 1130 using the OTT connection 1150, in which the wireless connection 1170 forms the last segment. More precisely, the teachings of these embodiments may improve the latency and thereby provide benefits such as reduced user waiting time, better responsiveness, extended battery lifetime.

A measurement procedure may be provided for the purpose of monitoring data rate, latency and other factors on which the one or more embodiments improve. There may further be an optional network functionality for reconfiguring the OTT connection 1150 between the host computer 1110 and UE 1130, in response to variations in the measurement results. The measurement procedure and/or the network functionality for reconfiguring the OTT connection 1150 may be implemented in the software 1111 of the host computer 1110 or in the software 1131 of the UE 1130, or both. In embodiments, sensors (not shown) may be deployed in or in association with communication devices through which the OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of the OTT connection 1150 may include message format, retransmission settings, preferred routing etc.; the reconfiguring need not affect the base station 1120, and it may be unknown or imperceptible to the base station 1120. Such procedures and functionalities may be known and practiced in the art. In certain embodiments, measurements may involve proprietary UE signaling facilitating the host computer's 1110 measurements of throughput, propagation times, latency and the like. The measurements may be implemented in that the software 1111, 1131 causes messages to be transmitted, in particular empty or ‘dummy’ messages, using the OTT connection 1150 while it monitors propagation times, errors etc.

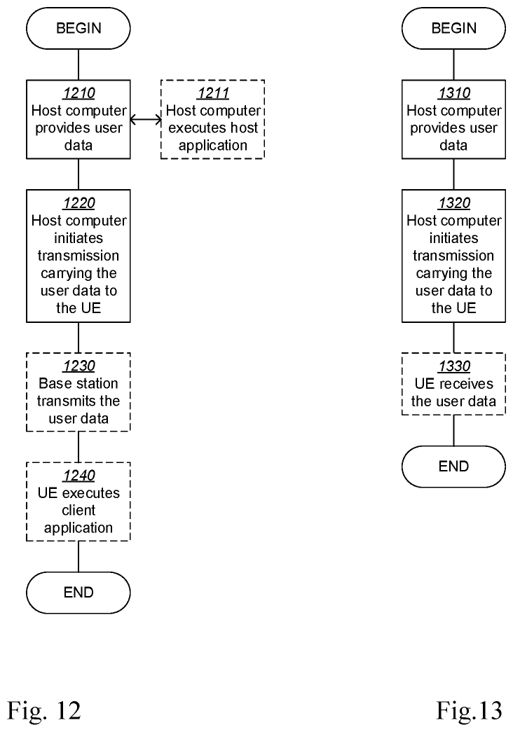

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 1210 of the method, the host computer provides user data. In an optional substep 1211 of the first step 1210, the host computer provides the user data by executing a host application. In a second step 1220, the host computer initiates a transmission carrying the user data to the UE. In an optional third step 1230, the base station transmits to the UE the user data which was carried in the transmission that the host computer initiated, in accordance with the teachings of the embodiments described throughout this disclosure. In an optional fourth step 1240, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 1310 of the method, the host computer provides user data. In an optional substep (not shown) the host computer provides the user data by executing a host application. In a second step 1320, the host computer initiates a transmission carrying the user data to the UE. The transmission may pass via the base station, in accordance with the teachings of the embodiments described throughout this disclosure. In an optional third step 1330, the UE receives the user data carried in the transmission.

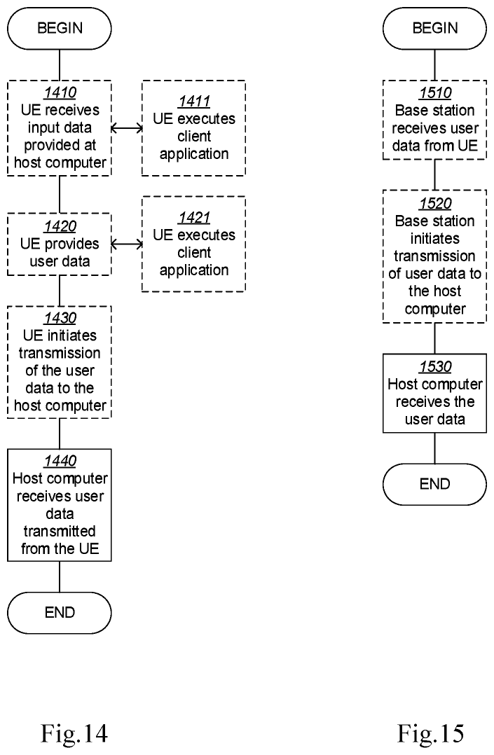

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 1410 of the method, the UE receives input data provided by the host computer. Additionally or alternatively, in an optional second step 1420, the UE provides user data. In an optional substep 1421 of the second step 1420, the UE provides the user data by executing a client application. In a further optional substep 1411 of the first step 1410, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1430, transmission of the user data to the host computer. In a fourth step 1440 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 1510 of the method, in accordance with the teachings of the embodiments described throughout this disclosure, the base station receives user data from the UE. In an optional second step 1520, the base station initiates transmission of the received user data to the host computer. In a third step 1530, the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-28. (canceled)

29. A method for generating a Demodulation Reference Signal (DM-RS) sequence for channel estimation and demodulation in a wireless network when transform pre-coding is enabled in transmissions, comprising:
determining a cyclic shift value for cyclic shift of a base sequence; and
generating a corresponding Demodulation Reference Signal (DM-RS) sequence based on the cyclic shift value.

30. The method of claim 29, wherein the cyclic shift value is different from one transmission to another.

31. The method of claim 29, further comprising: configuring the cyclic shift value in Radio Resource Control (RRC) signaling or Downlink Control Information (DCI) for each transmission or for a group of transmissions.

32. The method of claim 29, wherein the cyclic shift value is determined as a function of one or more configuration parameters of Radio Resource Control (RRC) or Downlink Control Information (DCI).

33. The method of claim 29, wherein the cyclic shift value is determined as a function of a cell ID or a fixed value.

34. The method of claim 32, wherein the cyclic shift value α is determined by a formula, α=mod (nPUSCH-Identity, N)*PI/N or α=mod (nPUSCH-Identity, N)*2PI/N, where N is a predefined or configured value, nPUSCH-Identity is a configuration parameter of RRC information element, mod ( )represents a Modulo function and PI is π value.

35. The method of claim 34, wherein N is a number of different cyclic shift values.

36. The method of claim 29, wherein the cyclic shift value is determined to be different between initial transmission and retransmissions.

37. The method of claim 36, wherein the cyclic shift value is determined to be different among retransmissions.

38. The method of claim 29, wherein the cyclic shift value is determined to be different for transmissions with repetition.

39. The method of claim 29, wherein the cyclic shift value is determined based on Radio Network Temporary Identity (RNTI) values.

40. The method of claim 29, wherein the cyclic shift value is determined based on signature IDs in case of Non-orthogonal Multiple Access (NoMA) transmission.

41. The method of claim 40, wherein the cyclic shift value α is determined by a formula, α=signature ID mod N, where N is a predefined value.

42. The method of claim 41, wherein N is a number of available cyclic shift values.

43. The method of claim 29, wherein the cyclic shift value is determined based on time or frequency configuration or allocation of a transmission; or the cyclic shift value is determined based on at least one of a slot number, a symbol number, a Resource Block (RB) number used in the transmission, and a preconfigured resource in the transmission, the preconfigured resource is periodicity in a configuration parameter ConfiguredGrantConfig.

44. The method of claim 29, wherein the determining comprises: randomly selecting the cyclic shift value by User Equipment (UE) from more than one cyclic shift candidate values.

45. The method of claim 29, wherein the cyclic shift value is determined based on at least one of factors: overloading factor; Modulation and Coding Scheme (MCS) value; user equipment (UE) measurement parameters; network measurement parameters; an Acknowledgement/Negative Acknowledgement (ACK/NACK) indication; time-frequency resources availability; and transmission time interval (TTI) requirement.

46. The method of claim 45, wherein the UE measurement parameters include Reference Signal Received Power (RSRP) and Reference Signal Received Quality (RSRQ); or the network measurement parameters include Signal to Noise Ratio (SNR), signal power, timing offset, and frequency offset based on transmissions from the UE.

47. The method of claim 29, wherein the method is applied to a configured grant-based Physical Uplink Shared Channel (PUSCH) transmission; or the method is applied to a dynamic grant-based PUSCH transmission.

48. A demodulation reference signal (DM-RS) sequence generation apparatus for channel estimation and demodulation in a wireless network, comprising:
one or more processors; and
one or more memories comprising computer program configured to, when executed by the one or more processors, cause the DM-RS sequence generation apparatus to execute the following acts:
determining a cyclic shift value for cyclic shift of a base sequence; and
generating a corresponding DMRS sequence based on the cyclic shift value.
